(19) United States
(12) Patent Application Publication
(10) Pub. No.: US 2026/0160286 A1
(43) Pub. Date: Jun. 11, 2026

(54) PONTOON CLIP WITH PULL TAB AND ADJUSTABLE PLACEMENT

(71) Applicant: Lippert Components, Inc., Elkhart, IN (US)

(72) Inventors: Ryan H. BIMES, Norristown, PA (US); Thomas F. WARD, Downingtown, PA (US); Robert R. SHEARER, Bradenton, FL (US)

(21) Appl. No.: 19/414,356

(22) Filed: Dec. 10, 2025

Related U.S. Application Data
(60) Provisional application No. 63/730,713, filed on Dec. 11, 2024.

(51) Int. Cl. F16B 5/06; B63B 17/02; F16B 2/20

(52) U.S. Cl. CPC F16B 5/0692; B63B 17/02; F16B 2/20

(57) ABSTRACT

A connector clip is securable to a rail profile including a forward corner and a bottom channel. The connector clip includes an outer pane and a connecting shelf extending perpendicularly from the outer panel. The outer panel and the connecting shelf are sized and configured to engage the forward corner of the rail profile. A pull tab extends perpendicularly from the connecting shelf and parallel to the outer panel. The pull tab extends beyond the outer panel at a distal end, and the pull tab includes a locking pawl at a proximal end disposed facing the outer panel. The locking pawl is engageable with the bottom channel.

### CROSS-REFERENCES TO RELATED APPLICATIONS

This application claims the benefit of U.S. Provisional Patent Application No. 63/730,713, filed Dec. 11, 2024, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a connector clip for securing a boat cover to a boat rail and, more particularly, to a connector clip in the form of a repositionable fastener that is readily attached and detached to an existing channel rail where the base of the clip extends down past the edge of the canvas and acts as a pull-to-release tab.

Conventional boat canvas or canopy connectors include a snap fastener with a male snap member secured to a surface of the boat frame attachable to a corresponding female snap member fixed to the canvas. Alignment and installation of the female snap member on the cover can be difficult and time-consuming and typically must be done after the male snap members are secured to the boat frame.

Existing solutions may require a pinch/squeeze-to-release tab, which can be burdensome. Additionally, some existing clips require a push-to-release tab, which can be non-intuitive. When removing the canvas, if a user pulls instead of pushes, the user can break clips thus requiring repair or replacement.

Current clips are typically sewn along the edge of the canvas cover. If a clip is damaged, the typical structure requires the cover to be sent in for repair and have a new clip sewn on. Having the clips sewn along the edge of the canvas also does not make it possible to reposition the clips. In some variations, if a clip is held by a hook or loop fastener with an adhesive back, the retention force is subject to the adhesive bond, and durability is subject to the degradation of the adhesive.

Existing solutions with clips sewn along the canvas of the cover require the number and position of the clips to be known prior to production of the canvas. Adjustments cannot be made on site without requiring the canvas to be resewn.

### SUMMARY

The canvas clip of the described embodiments is a quick-attach clip to secure boat covers such as pontoon covers onto their rails by utilizing a clip that interfaces with the channel in the existing rail. The clip is fastened with a hook or loop fastener to the canvas, which supports the ability to reposition clips and allows for quick and easy replacements with no impact to the canvas or cover.

A quick release pull tab allows the user to remove the cover quickly with one easy touch. The pull tab is more intuitive than the push tab or pinch/squeeze release on current clips. The geometry of the clip allows for installation on both flat and curved rails.

The canvas clip may include two slots with one on either side of the mounting clip that allow a strip of hook or loop fastener to feed through the clip and secure the clip to the cover mechanically. This means the hook or loop fastener strips no longer require an adhesive backing to secure and hold the clip. Both slots in the clip may contain teeth that are oriented such that when the canvas is pulled tight, the teeth stop the clip from sliding relative to the hook or loop strip.

In an exemplary embodiment, a connector clip is securable to a rail profile including a forward corner and a bottom channel. The connector clip includes an outer panel, and a connecting shelf extending substantially perpendicular from the outer panel. The outer panel and the connecting shelf are sized and configured to engage the forward corner of the rail profile. A pull tab extends substantially perpendicular from the connecting shelf and substantially parallel to the outer panel. The pull tab extends beyond the outer panel at a distal end, and the pull tab includes a locking pawl at a proximal end disposed facing the outer panel. The locking pawl is engageable with the bottom channel.

The bottom channel of the rail profile may include a ledge, and the locking pawl may be configured to engage the ledge of the rail profile.

The outer panel may include a slot. The outer panel may include a pair of slots adjacent opposite sides of the outer panel. The slots may include teeth. The connector clip may additionally include a strip of hook or loop material secured in the slots and engaging the teeth.

The outer panel may be substantially U-shaped including outer legs and a central opening, and the pull tab may be aligned with the central opening. The outer panel may include a slot in at least one of the outer legs. The outer panel may include a slot in each of the outer legs.

The pull tab may be bent such that the distal end of the pull tab is closer to the outer panel than the proximal end of the pull tab.

A distance between the locking pawl and the outer panel may be smaller than a width of the rail profile forward corner. The locking pawl may include a cam surface that engages the rail profile forward corner when securing the connector clip to the rail profile, where the cam surface deflects the locking pawl away from the outer panel until the locking pawl is positioned over the forward corner, after which the locking pawl snaps into engagement in the bottom channel. The pull tab may be configured to displace the locking pawl out of engagement in the bottom channel when the pull tab is manually deflected toward the outer panel.

In another exemplary embodiment, a canvas connector clip is securable to a rail profile with a forward corner and a bottom channel for securing a canvas cover having one part of a hook or loop fastener to the rail profile. The connector clip includes an outer panel, a connecting shelf extending perpendicularly from the outer panel, and a pull tab extending substantially perpendicular from the connecting shelf and substantially parallel to the outer panel. The pull tab extends below the outer panel at a distal end, and the pull tab includes a locking pawl at a proximal end disposed facing the outer panel and extending above the connecting shelf. The locking pawl is engageable with the bottom channel. A securing material connected to the outer panel includes an opposite part of the hook or loop fastener.

In yet another exemplary embodiment, a connector clip is securable to a rail profile including a forward corner and a bottom channel. The connector clip includes an outer panel with at least one opening, and a connecting shelf extending substantially perpendicular from the outer panel, where the outer panel and the connecting shelf are sized and configured to engage the forward corner of the rail profile. The connector clip also includes a strip of hook or loop material securable in the at least one opening.

### BRIEF DESCRIPTION OF THE DRAWINGS

These and other aspects and advantages will be described in detail with reference to the accompanying drawings, in which:

FIG. 1 is a perspective view of an exemplary connector clip according to the described embodiments;

FIG. 2 shows the connector clip of FIG. 1 secured to a rail profile;

FIG. 3 is a perspective view of a variation including a bent pull tab;

FIG. 4 is a front view of the connector clip shown in FIG. 3;

FIG. 5 is a side view of the connector clip shown in FIG. 3; and

FIG. 6 shows the connector clip with the hook or loop material secured in the slots.

### DETAILED DESCRIPTION

The connector clip of the described embodiments will be described in the context of a cover securable to a pontoon rail profile. The application is exemplary, and those of ordinary skill in the art will appreciate that the design and function of the described connector clip is readily applicable to other crafts and varying rail profiles.

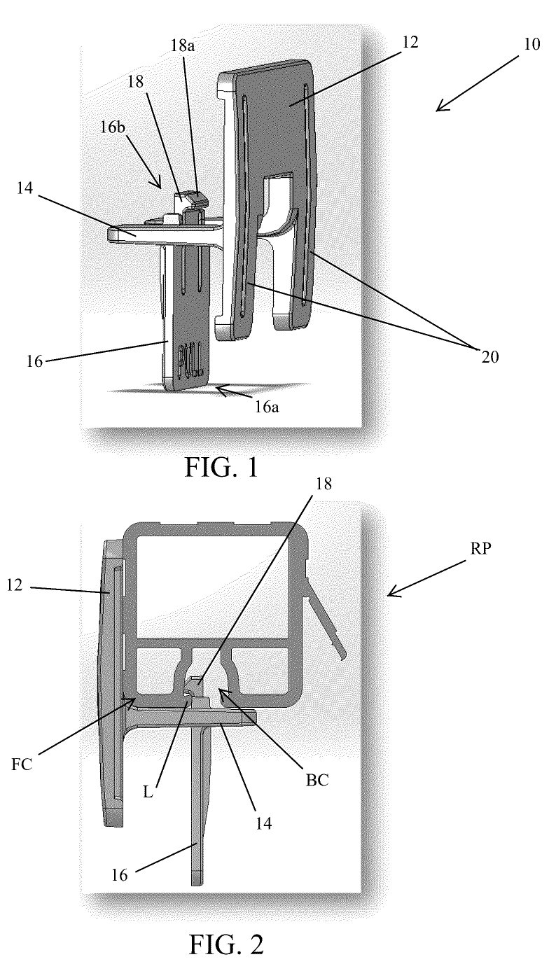

FIG. 1 is a perspective view of an exemplary connector clip 10, and FIG. 2 shows the connector clip 10 secured to a rail profile RP. The rail profile RP includes a forward corner FC and a bottom channel BC. In some variations, the bottom channel BC includes a ledge L.

The connector clip 10 includes an outer panel 12 and a connecting shelf 14 extending substantially perpendicularly from the outer panel 12. As shown in FIG. 2, an outer side of the outer panel 12 may be slightly curved. The outer panel 12 and the connecting shelf 14 are sized and configured to engage the forward corner FC of the rail profile RP. That is, the joint between the outer panel 12 and the connecting shelf 14 essentially defines a 90-degree seat that is sized and shaped to securely engage the forward corner FC.

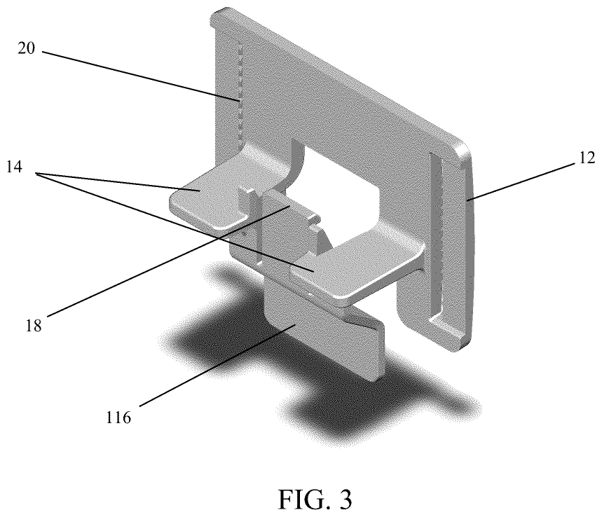

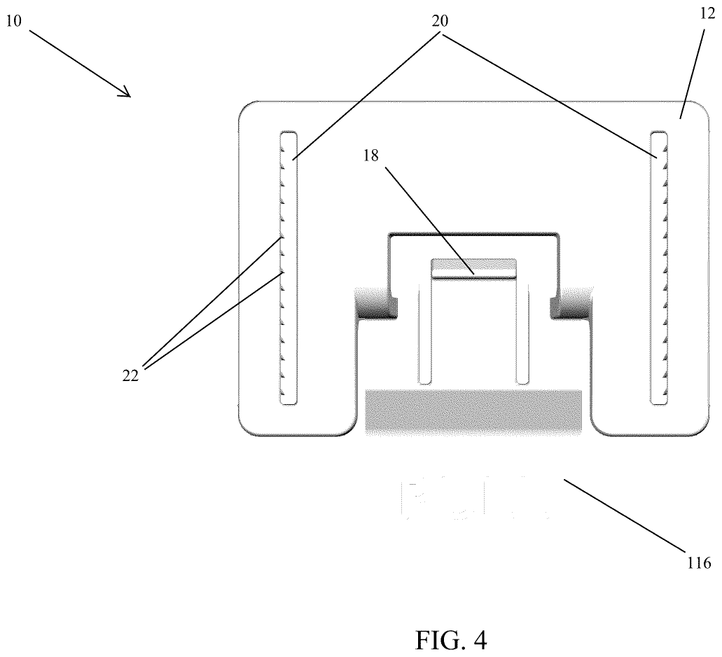

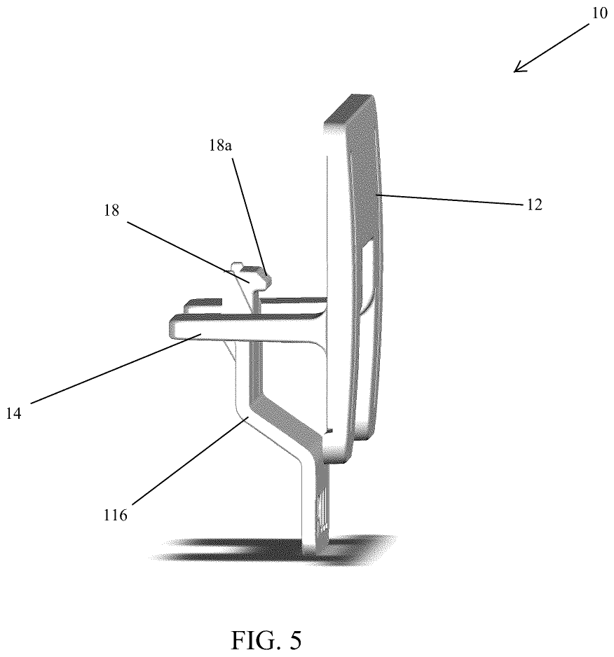

A pull tab 16 extends substantially perpendicularly from the connecting shelf 14 and is substantially parallel to the outer panel 12. FIGS. 3-5 show a variation where a modified pull tab 116 is bent such that the distal end of the pull tab 116 is closer to the outer panel 12 than the proximal end of the pull tab 116. In some embodiments, the pull tab 16, 116 may extend beyond the outer panel 12 at a distal end 16a (FIG. 1).

Additionally, the pull tab 16, 116 may include a locking pawl 18 at a proximal end 16b disposed facing the outer panel 12. The locking pawl 18 is engageable with the bottom channel BC of the rail profile RP. Specifically, the locking pawl 18 is configured to engage the ledge L of the rail profile RP.

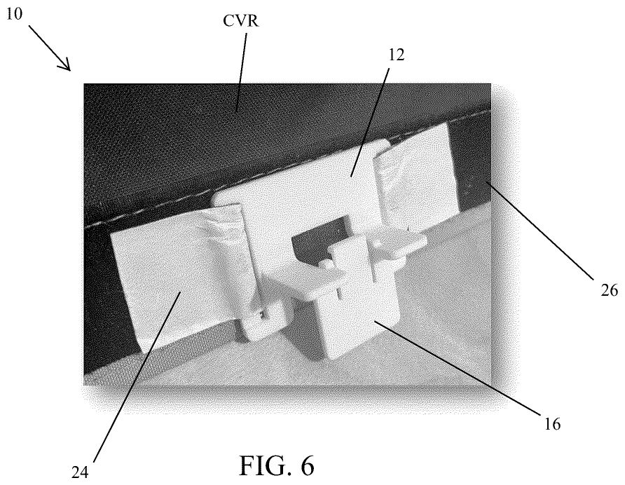

As shown, the outer panel 12 may be substantially U-shaped including outer legs and a central opening. The pull tab 16, 116 is aligned with the central opening. One or both of the legs of the U-shape includes a slot 20 including teeth 22 (FIG. 4). The slots 20 on either side of the outer panel 12 allows a strip of hook or loop material 24 to feed through the clip and secure the clip to the boat cover CVR. See FIG. 6. The teeth 22 are oriented such that when the canvas is pulled tight, the teeth 22 stop the clip from sliding relative to the hook or loop strip 24.

With continued reference to FIGS. 1 and 2, a distance between the locking pawl 18 and the outer panel 12 is smaller than a width of the rail profile forward corner FC. The locking pawl 18 includes a cam surface 18a that engages the rail profile forward corner FC when securing the connector clip 10 to the rail profile RP. The cam surface 18a deflects the locking pawl 18 away from the outer panel 12 until the locking pawl 18 is positioned over the forward corner FC, after which the locking pawl 18 snaps into engagement in the bottom channel BC. With the hook or loop material/fastener strips 24 secured in the slots 20, the connector clips 10 can be repositioned on site. The complementary part 26 of the hook or loop material may be sewn on a border of the boat cover (FIG. 6), and the connector clips 10 can be readily secured in any desired position along the boat cover perimeter.

The pull tab 16, 116 is configured to displace the locking pawl 18 out of engagement in the bottom channel BC when the pull tab 16, 116 is manually deflected toward the outer panel 12. As shown, the pull tab 16, 116 may include the word “PULL” on the outer panel side of the pull tab 16, 116.

With the connector clips of the described embodiments, the clips can be quickly disengaged with one pulling motion. Removal of the clip is more intuitive than existing push to release clips. Moreover, the pull force required to disengage the clip is significantly below the yield strength of the clip resulting in fewer broken/damaged clips. Using the hook or loop fastener to attach canvas clips allows the user to reposition the clips on site, no longer requiring the canvas to be sent in for sewing. This provides flexibility in the placement of the clips to accommodate design elements like doors, accessories, fence styling features, etc. Additionally, this greatly reduces repair/replacement costs and time. Still further, the hook or loop strips no longer require an adhesive backing to secure to and hold the clip, thereby reducing cost and providing a secure lock between the clip and the hook or loop strips.

Teeth in the slots that hold the hook or loop strip relative to the clip avoid “scrunching” of the fastener strip when the canvas is pulled tight. The number of clips can be modified on site to adjust to different radii in the pontoon fence or to sections that require a greater tension in the canvas.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A connector clip securable to a rail profile including a forward corner and a bottom channel, the connector clip comprising:
an outer panel;
a connecting shelf extending substantially perpendicular from the outer panel, wherein the outer panel and the connecting shelf are sized and configured to engage the forward corner of the rail profile; and
a pull tab extending substantially perpendicular from the connecting shelf and substantially parallel to the outer panel, the pull tab extending beyond the outer panel at a distal end, and the pull tab including a locking pawl at a proximal end disposed facing the outer panel, wherein the locking pawl is engageable with the bottom channel.

2. A connector clip according to claim 1, wherein the bottom channel of the rail profile includes a ledge, and wherein the locking pawl is configured to engage the ledge of the rail profile.

3. A connector clip according to claim 1, wherein the outer panel comprises a slot.

4. A connector clip according to claim 3, wherein the outer panel comprises a pair of slots adjacent opposite sides of the outer panel.

5. A connector clip according to claim 4, wherein the slots comprise teeth.

6. A connector clip according to claim 5, further comprising a strip of hook or loop material secured in the slots and engaging the teeth.

7. A connector clip according to claim 3, further comprising a strip of hook or loop material secured in the slot.

8. A connector clip according to claim 1, wherein the outer panel is substantially U-shaped including outer legs and a central opening, and wherein the pull tab is aligned with the central opening.

9. A connector clip according to claim 8, wherein the outer panel comprises a slot in at least one of the outer legs.

10. A connector clip according to claim 8, wherein the outer panel comprises a slot in each of the outer legs.

11. A connector clip according to claim 1, wherein the pull tab is bent such that the distal end of the pull tab is closer to the outer panel than the proximal end of the pull tab.

12. A connector clip according to claim 1, wherein a distance between the locking pawl and the outer panel is smaller than a width of the rail profile forward corner.

13. A connector clip according to claim 12, wherein the locking pawl includes a cam surface that engages the rail profile forward corner when securing the connector clip to the rail profile, the cam surface deflecting the locking pawl away from the outer panel until the locking pawl is positioned over the forward corner, after which the locking pawl snaps into engagement in the bottom channel.

14. A connector clip according to claim 13, wherein the pull tab is configured to displace the locking pawl out of engagement in the bottom channel when the pull tab is manually deflected toward the outer panel.

15. A canvas connector clip securable to a rail profile including a forward corner and a bottom channel for securing a canvas cover having one part of a hook or loop fastener to the rail profile, the connector clip comprising:
an outer panel;
a connecting shelf extending perpendicularly from the outer panel;
a pull tab extending substantially perpendicular from the connecting shelf and substantially parallel to the outer panel, the pull tab extending below the outer panel at a distal end, and the pull tab including a locking pawl at a proximal end disposed facing the outer panel and extending above the connecting shelf, wherein the locking pawl is engageable with the bottom channel; and
a securing material connected to the outer panel and including an opposite part of the hook or loop fastener.

16. A canvas connector clip according to claim 15, wherein the outer panel comprises a slot, and wherein the securing material is connected to the outer panel via the slot.

17. A canvas connector clip according to claim 16, wherein the outer panel comprises a pair of slots adjacent opposite sides of the outer panel.

18. A canvas connector clip according to claim 17, wherein the slots comprise teeth.

19. A canvas connector clip according to claim 15, wherein the outer panel is substantially U-shaped including outer legs and a central opening, and wherein the pull tab is aligned with the central opening.

20. A connector clip securable to a rail profile including a forward corner and a bottom channel, the connector clip comprising:
an outer panel including at least one opening;
a connecting shelf extending substantially perpendicular from the outer panel, wherein the outer panel and the connecting shelf are sized and configured to engage the forward corner of the rail profile; and
a strip of hook or loop material securable in the at least one opening.

21. A connector clip according to claim 20, further comprising a pull tab extending substantially perpendicular from the connecting shelf and substantially parallel to the outer panel, the pull tab extending beyond the outer panel at a distal end, and the pull tab including a locking pawl at a proximal end disposed facing the outer panel, wherein the locking pawl is engageable with the bottom channel.
